(19) United States
(12) Patent Application Publication
(10) Pub. No.: US 2006/0283110 A1
(43) Pub. Date: Dec. 21, 2006

(54) Secure bracket for rapid installation

(75) Inventor: Samuel J. Ferguson, Weston, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(73) Assignee: K & T Stoneworks, Inc.

(21) Appl. No.: 11/156,427

(22) Filed: Jun. 20, 2005

(51) Int. Cl. E06B 1/04

(52) U.S. Cl. 52/211

(57) ABSTRACT

A decorative architectural ornament and bracket are disclosed that allow for rapid and secure installation of said decorative architectural ornament to a wall or substrate without puncturing the ornament.

### BACKGROUND OF THE INVENTION

1. Field of the Invention

This invention relates generally to a novel bracket and its use to attach a decorative architectural ornament to a wall or substrate.

2. Background Art

Decorative non-structural architectural ornaments have been used throughout the centuries to adorn buildings, exteriors and interiors. Originally, natural materials were used to produce these ornaments. Stone was routinely used in Greek architecture, and wood in Victorian. For a variety of reasons, a trend to substitute these natural materials with manmade materials has evolved. For example, redwood architectural ornaments are increasingly hard to obtain because of the ban on redwood farming due to the threatened extinction of the redwood tree. Stone and marble is heavy and requires special skills and knowledge to properly work with it and to permanently affix it to a building in a manner that its weight can be supported. In addition, natural materials must be maintained or they deteriorate. There are additional reasons not referenced herein that have led to an increase in the use of manmade architectural ornaments.

Even with the transition from natural materials to manmade materials, there have always been difficulties encountered with the attachment of architectural ornaments. For example, U.S. Pat. No. 4,845,912 to Baker teaches a self-aligning architectural panel assembly. In the Background of the Invention, Baker points out the known attachment mechanisms, including the use of Velcro™-brand hook and loop fasteners. Baker also points out the known detriments of these methods, such as alignment and attachment strength issues. With the evolution from natural products, an additional problem has evolved. Puncturing man-made materials to attach them to structures weakens the material. If the products are hollow, the punctures may cause the product to crack and fill with rainwater, condensation, and/or other airborne materials that could develop weight load build up, stress fractures, and potentially fall off the wall or substrate.

Therefore, there is a need to provide a system and method of attaching architectural ornaments to walls or substrates in a secure manner without puncturing the architectural ornaments.

### SUMMARY OF THE INVENTION

The instant invention provides a system and method to securely attach a decorative architectural ornament to a wall or substrate. The decorative architectural ornament is provided with an inner configuration that allows the ornament to be attached to the wall or substrate with a novel structural bracket. The bracket is mounted to the wall or substrate and is configured to slidably receive the architectural ornament. The architectural ornament slides into position tightly onto the secure bracket. The use of an exterior grade construction adhesive between the secure bracket and the decorative architectural ornament can provide an additional bond that allows the ornament to become a permanent fixture of the wall or substrate. The mounting arrangement of the invention permits the secure, permanent mounting of architectural ornaments to buildings without puncturing the ornaments or otherwise passing a connector through the ornament.

It is an object of the present invention to provide a novel system for mounting decorative architectural ornaments to walls or substrates.

It is another object to provide a system for mounting decorative architectural ornaments to walls or substrates without piercing the ornament or otherwise crossing a fastener through the ornament.

It is an object of the present invention to reduce the labor and time required to install decorative architectural ornaments to walls or substrates.

It is another object of the present invention to provide a method for accurately aligning and fitting decorative architectural ornaments to walls or substrates. By attaching an architectural ornament using the secure bracket and the method of mounting of this invention, a superior fit is achieved between the architectural ornament and the wall or substrate.

These and other objects and features of the invention will be more readily understood from a consideration of the following detailed description, taken with the accompanying drawings, in which corresponding parts are indicated by corresponding numerals.

### BRIEF DESCRIPTION OF THE DRAWINGS

FIG. 1 is a right side cross-sectional elevational view of one embodiment of the present invention.

FIG. 2 is a top plan view of one embodiment of the bracket of the present invention.

FIG. 3 is a front elevational view of the bracket of FIG. 2.

FIG. 4 is a left side elevational view of the bracket of FIG. 2.

FIG. 5 is a right side cross-sectional elevational view of a second embodiment of the present invention.

FIGS. 6 and 7 are perspective views illustrating the 270 or 90 degree rotation of the decorative architectural ornament to permit different orientations during installation.

### DETAILED DESCRIPTION OF THE INVENTION INCLUDING SEVERAL PREFERRED EMBODIMENTS

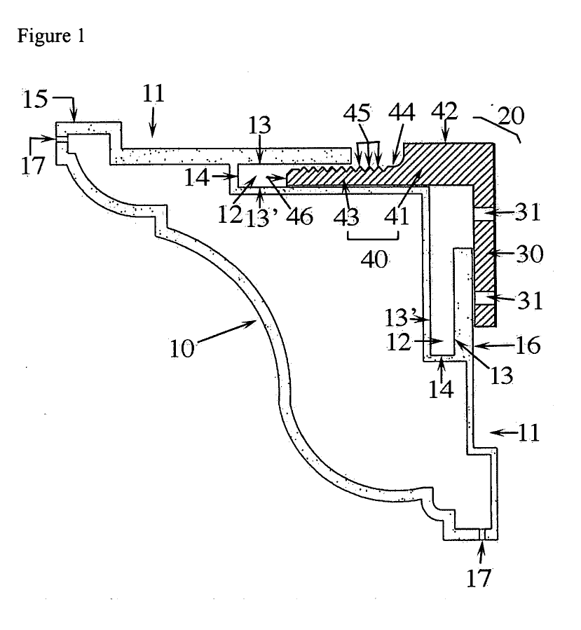

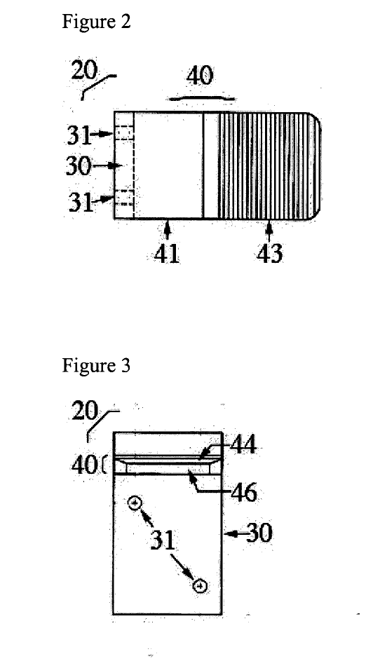

Referring now to the drawings, FIGS. 1-7 depict two modes of practicing the present invention. It is to be understood, however, that departures may be made in the specific structural assembly and use of the invention without departing form the spirit and scope of the invention.

As depicted in FIG. 1, a decorative architectural ornament 10 is attached to a wall or substrate 50 by a bracket 20. In the embodiment depicted in FIG. 1, the decorative architectural ornament 10 is substantially hollow. However, the present invention is not limited to substantially hollow decorative architectural ornaments. Any decorative architectural ornaments 10 can be used with the teachings of the present invention as long as the ornaments include structure for attaching the ornament to a wall or substrate without using fasteners which pass through the ornament. The term wall or substrate 50 as used throughout the specification and claims refers to any surface on which a decorative architectural ornament can be installed and includes interior and exterior walls, ceilings, floors, windows, doors, cabinets, counters, and the like.

The decorative architectural ornament 10 is manufactured to include an inner configuration which defines two slots; a leveling slot 11 and a gripping slot 12. The gripping slot 12 mates with the bracket 20 to secure the decorative architectural ornament 10 to the wall or substrate 50. In addition, special weep holes 17 may be formed in the decorative architectural ornament 10. The weep holes 17 allow any water build-up, condensation and/or other airborne materials to escape and evaporate from the installed decorative architectural ornament 10.

Leveling slot 11 provides for flush mounting of the decorative architectural ornament 10. The embodiment of the decorative architectural ornament 10 of FIG. 1 comprises two leveling slots 11. This allows for reversible mounting of the decorative architectural ornament 10 in either of the orientations shown in FIG.s 6 and 7. However, this is not required to meet the limitations of the present invention. A decorative architectural ornament 10 with only one leveling slot 11 is within the scope of this invention.

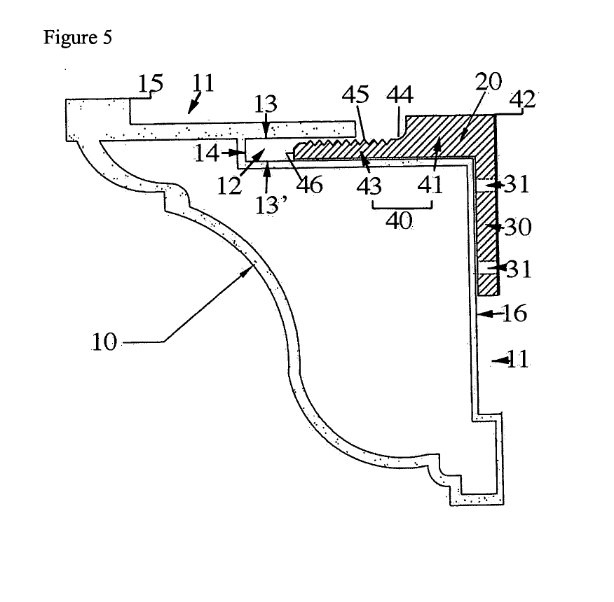

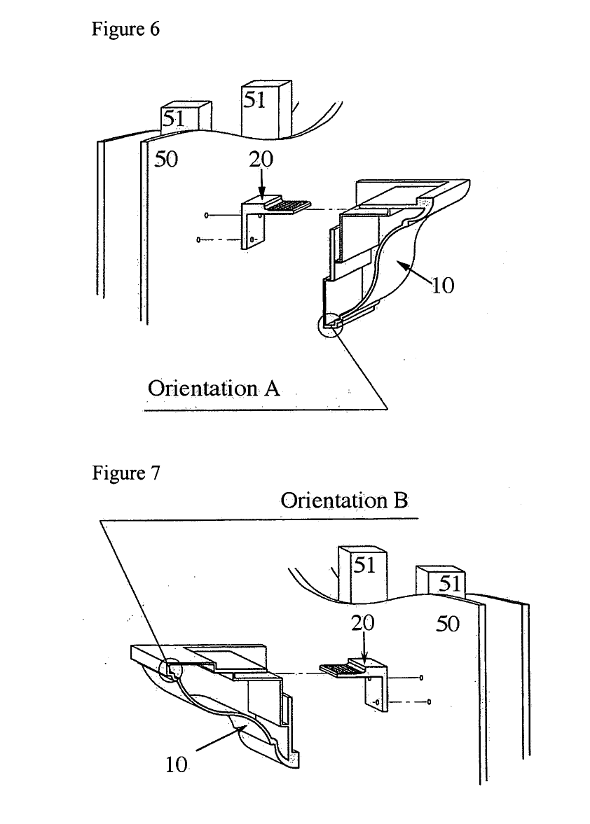

Gripping slot 12 is provided to secure the decorative architectural ornament 10 to the bracket 20. The embodiment of the decorative architectural ornament 10 of FIGS. 1 through 4 comprises two gripping slots 12. This allows for the mounting of the decorative architectural ornament 10 in either orientation, as depicted in FIGS. 6 and 7. However, once again, two gripping slots 12 are not required to meet the limitations of the present invention. A decorative architectural ornament 10 could be created with only one gripping slot 12, as depicted in the alternate embodiment provided in FIG. 5.

The L-shaped bracket 20 comprises two arms, arm 30 and arm 40. Arm 30 is used to secure the bracket 20 to wall or substrate 50 via screws, nails, or any suitable fastener arrangement through mounting holes 31. The screws, nails or other mounting mechanism should be flush with or sunken below the surface of arm 30 to permit arm 30 to be flush against wall 50 or abutment flange 16 so as to permit proper alignment of the decorative architectural ornament 10. Preferably, the bracket 20 is installed on a stud 51 (shown in FIGS. 6 and 7) or similar structural element. As depicted in FIGS. 1-7, arm 30 employs two mounting holes 31. Once again, this embodiment is just one of many that may be utilized to attach the bracket 20 to a wall or substrate 50. However, any embodiment chosen must be durable enough to withstand the elements of nature, for outdoor applications, and secure enough to withstand any potential indoor elements, such as children climbing on them or throwing objects at them, for indoor applications.

Arm 40 is used to receive the decorative architectural ornament 10 in locking engagement. Arm 40 comprises two components: the base 41 and the gripping end 43. The base 41 connects the gripping end 43 to arm 30. Although not depicted as such in FIG. 1, preferably the top surface 42 of base 41 is located at or near the same height (i.e. in the same plane) as the top surface 15 of the decorative architectural ornament 10. This allows for easier alignment of the decorative architectural ornament 10 during installation because the installer need only align the top surface 42 of base 41 at the location in which the top surface 15 of the decorative architectural ornament 10 is desired to be located. In the alternative, and as depicted in FIG. 1, it may be necessary due to structural constraints or other unknowns to locate the top surface 42 of the base 41 in a plane different from the top surface 15 of the decorative architectural ornament 10. If space is an issue, it may be necessary to have the top surface 42 of the base 41 in the same plane as the top surface 44 of the gripping end 43. However, it is preferable to have the top 42 surface of the base 41 higher than the top surface 44 of the gripping end 43 so that installation is easier.

In FIG. 1, gripping slot 12 is formed by two side walls 13, 13′ and an end wall 14. Gripping slot 12 receives gripping end 43 thereby securing the decorative architectural ornament 10 to the bracket 20. As depicted in FIG. 1, side walls 13, 13′ are parallel. However, they are not required to be and gripping slot 12 can be tapered from one end to the other. For example, side walls 13, 13′ could be tapered rather than parallel thereby eliminating end wall 14. End wall 14 could also blend into side walls 13, 13′ so that the resulting configuration forms a C-shape. The final configuration of side walls 13, 13′ and end wall 14 will depend on the manufacturing technique used to prepare the decorative architectural ornament 10. No matter the shape of gripping slot 12, gripping end 43 should be just slightly thicker than the distance between side walls 13, 13′. This configuration provides part of the locking mechanism that secures the decorative architectural ornament 10 to the wall or substrate 50. The end 46 of gripping end 43 is not required to contact end wall 14 to perform according to the teachings of this invention. Of course, the resulting structure is more secure when there is more surface area of contact between gripping end 43 and side walls 13, 13′.

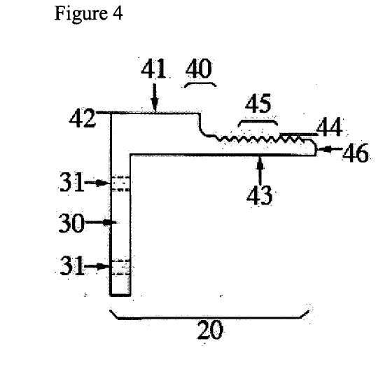

Gripping end 43 may also be tapered from one end to the other. This embodiment is evident in FIG. 4 where top surface 44 is shown sloped. The top surface 44 of gripping end 43 may be formed, at least partially, of teeth 45. These teeth 45 grip side wall 13 of gripping slot 12 thereby providing additional strength to the bond between the decorative architectural ornament 10 and the bracket 20. Side wall 13 could also be molded to include teeth (not shown), once again providing additional strength to the bond between the decorative architectural ornament 10 and the bracket 20. In one embodiment of the present invention, an exterior construction adhesive (not shown) can be added to the teeth 45 of gripping end 43 and to the abutment flange 16 of the decorative architectural form 10. In another embodiment, an exterior construction adhesive (not shown) can be added to gripping slot 12 instead of the teeth 45 of gripping end 43. The construction adhesive (not shown) provides additional bonding of the decorative architectural ornament 10 to the bracket 20.

It can therefore be appreciated that the time and skill required to install decorative architectural ornament 10 is greatly reduced through the teaching of the present invention. An installer need only properly locate bracket 20 and slide decorative architectural ornament 10 thereon. To ensure further security in the connection of the decorative architectural ornament 10 with the bracket 20, an exterior construction adhesive may be applied to the teeth 45 of gripping end 43 and to the abutment flange 16 of the decorative architectural ornament 10 to unitize, cold weld, and further bond the decorative architectural ornament 10 to the secure bracket 20.

### EXAMPLE 1

A new house is being constructed in South Florida. The home owner wishes to have decorative architectural ornaments 10 of marble installed thereon. Unfortunately, marble is very expensive to purchase and very difficult to work with. The home owner is not able to find affordable marble and the skilled craftsmen to install it at his new house. The home owner performs an internet search for marble architectural ornaments and finds the web site of the assignee of the present invention. After personally seeing the quality of the decorative architectural ornaments 10, the home owner orders the required amount of simulated marble decorative architectural ornaments 10 for installation on the exterior of his new house.

One of the final steps in completing construction of the home is installation of the decorative architectural ornaments 10. The top surface 42 of the base 41 of the bracket 20 utilized in this example is located at the same height (i.e. in the same plane) as the top surface 15 of the decorative architectural ornament 10. Therefore, the installer can place the bracket 20 at the junction of the exterior wall 50 and the roof eave. The installer should ensure that this junction is close to properly aligned so that the decorative architectural ornament 10 does not look skewed after installation. This can be determined using known methods in the art, such as an old-fashioned level or a laser. A perfect level is not required because minor variations in level can be compensated for by the use of caulk in any resulting minor gaps between the decorative architectural ornament 10 and the wall 50 or roof.

After determining that the junction of the wall 50 and the roof is level, the installer marks the location of the mounting holes 31 of the bracket 20 on the wall 50. As this is an exterior installation, the installer plans to use concrete screws sold under the trademark Tapcon® to secure the bracket 20 to the wall 50. The installer pre-drills the proper holes for the concrete screws. The installer aligns the mounting holes 31 of the bracket 20 with the newly drilled holes in the wall 50 and secures the bracket 20 to the wall 50 with the screws. The screws are counter-sunk below the level of the bracket 20 so as not to interfere with installation of the decorative architectural ornament 10. The bracket 20 is now secured to the wall 50.

The new home is located in South Florida, which is subject to high winds from hurricanes and even tornadoes. Therefore, the installer adds an exterior construction adhesive to the teeth 45 of the bracket 20 and to the abutment flange 16 of the architectural ornament 10. This adhesive provides added resistance to the elements of the South Florida environment. The installer then slides the architectural ornament 10 onto the bracket 20, mating gripping slot 12 of the architectural ornament 10 with the gripping end 43 of the bracket 20. The installer checks for any gaps between the wall 50, eave and the architectural ornament 10 and applies weather resistant caulk thereto, if necessary. The installer moves onto the location of the next architectural ornament 10 and repeats this performance.

### EXAMPLE 2

The same home owner is so happy with the exterior appearance of his new home, and particularly the inexpensive and easily installed architectural ornaments 10, that he contacts the assignee of the present invention to determine if interior ornamentation is also available. He quickly learns of the large variety of interior ornamentation that can also be accomplished using the teachings of the present invention. He decides to purchase simulated redwood ornaments for his new living room.

The installer brings the simulated redwood ornaments 10 to the home. The top surface 42 of the base 41 of the bracket 20 utilized in this example is located below (i.e. in a different plane than) the top surface 15 of the decorative architectural ornament 10. Therefore, the installer has to properly locate the bracket 20 on the wall 50. The difference between the top surface 42 of the base 41 of the bracket 20 and the top surface 15 of the decorative architectural ornament 10 is ten inches, so the installer measures the location on the wall 50 ten inches below the ceiling and then aligns the bracket 20. Once again, perfect alignment is not required because natural materials do not occur perfectly aligned. However, less work will be required of the installer if the alignment is perfect because there will be no or fewer resulting spaces requiring caulk.

After determining the proper location for the bracket 20, the installer marks the location of the mounting holes 31 of the bracket 20 on the wall 50. As this is an interior installation, the installer plans to use screws and anchors to attach the bracket 20 to the wall 50. The home owner has several young children and the installer does not want the decorative architectural ornament 10 being bumped from the wall 50 by childplay. The installer secures the bracket 20 to the wall 50.

The homeowner wants to be able to redecorate the interior in the future. Therefore, no glue is used in the present application. The installer slides the architectural ornament 10 onto the bracket 20, mating gripping slot 12 of the architectural ornament 10 with the gripping end 43 of the bracket 20. The installer checks for any gaps between the wall 50, ceiling and the architectural ornament 10 and applies caulk thereto, if necessary. The installer moves onto the location of the next architectural ornament 10 and repeats this performance.

Various modifications and alterations of this invention will become apparent to those skilled in the art without departing from the scope and spirit of this invention, and it is understood that this invention is not limited to the illustrative embodiments set forth hereinbefore.

What is claimed is:

1. A decorative architectural ornament and bracket, said decorative architectural ornament comprising a gripping slot defined by two side walls;
said bracket comprising two arms;
wherein the first arm defines mounting holes;
wherein the second arm defines a gripping end;
wherein said first arm is adapted to be secured to a wall or substrate and said gripping end of said second arm is adapted to be mated with said gripping slot of said decorative architectural ornament, thereby securing said decorative architectural ornament to a wall or substrate.

2. The decorative architectural ornament and bracket of claim 1, wherein the decorative architectural ornament further comprises weep holes.

3. The decorative architectural ornament and bracket of claim 1, wherein the gripping end of the bracket defines one or more teeth.

4. A method for installing a decorative architectural ornament on a wall or substrate without puncturing said decorative architectural ornament, said method comprising:
a) providing a decorative architectural ornament which defines a gripping slot;
b) providing a bracket which includes two arms;
wherein the first arm defines mounting holes; and
wherein the second arm defines a gripping end;
c) securing the first arm of the bracket to a wall or substrate;
d) mating the gripping end of the second arm of the bracket to the gripping slot of the decorative architectural ornament.

5. The method of claim 4 further comprising applying an adhesive to either the gripping end of the second arm of the bracket or the gripping slot prior to mating the gripping end to the gripping slot of the decorative architectural ornament.

6. A bracket and non-structural architectural form, comprising:
an L-shaped bracket member having a first bracket leg and a second bracket leg, the first bracket leg adapted to be affixed to a mounting surface using mechanical fasteners;
a non-structural architectural form adapted to be mounted to a mounting surface, the form defining a cavity adapted to receive the second bracket leg in mating engagement.

7. The bracket and non-structural architectural form of claim 6, the non-structural architectural form further comprising an abutment flange, wherein the first bracket leg is adapted to be contacted by the abutment flange when the form is mounted to the bracket.

8. The bracket and form of claim 6, wherein the abutment flange and cavity are disposed in flanges which are perpendicular to each other.

9. The bracket and form of claim 6, wherein the second bracket leg comprises one or more teeth.

10. The bracket and form of claim 6, wherein the non-structural architectural form further comprises one or more weep holes.
